(19) United States
(12) Patent Application Publication
(10) Pub. No.: US 2005/0001857 A1
(43) Pub. Date: Jan. 6, 2005

(54) Image display apparatus and electronic apparatus

(76) Inventors: Tomoki Nakakita, Osaka (JP); Makoto Yamakura, Osaka (JP); Mika Nakamura, Osaka (JP); Takashi Koizumi, Shiga (JP)

Correspondence Address: McDermott Will & Emery, 600 13th Street N W, Washington, DC, 20005-3096, US

(21) Appl. No.: 10/481,566

(22) PCT Filed: Jun. 21, 2002
(86) PCT No.: PCT/JP02/06206

(30) Foreign Application Priority Data
Jun. 22, 2001 (JP) 20011-189234

(51) Int. Cl. G09G 5/10

(52) U.S. Cl. 345/690

(57) ABSTRACT

An image display device of this invention includes image memory (3) which is constructed of SRAM and which does not need any refreshing operation, image memory (3) being composed of MSB division memory (13) for storing MSB data of each pixel data item and lower-order bit division memory (14) for storing lower-order bit data other than the MSB data. In a normal mode MSB division memory (13) and lower-order bit division memory (14) are driven to cause the MSB data and the lower-order bit data to be read/written, whereas in an electric power saving mode only MSB division memory (13) is driven with lower-order bit division memory (14) remaining undriven to cause the MSB data to be read/written.

### TECHNICAL FIELD

The present invention relates to image display devices and, more particularly, to an image display device capable of realizing electric power saving and an electronic apparatus incorporating such an image display device.

### BACKGROUND ART

In recent years, image display devices for use in small-sized electronic apparatus such as mobile telephones have their respective display screens with increasing number of pixels and increasing number of displayable colors. An increase in electric power consumption with this trend has been concerned about. As a result, electric power saving has been strongly desired.

For example, a mobile telephone has to be capable of displaying all colors using all the pixels in normal use, but minimum display is sufficient for such a mobile telephone in a standby (waiting) state. For this reason the art of providing a non-display area during such a standby state to reduce electric power consumption is becoming known means. For example, Japanese Patent Laid-Open Publication No. HEI 11-184434 discloses a display device configured to allow the user to establish a display area and a non-display area. This display device is configured to display an image only in an area established by the user and not to display any image in other area, as shown in FIGS. 1(a) and 1(b). By thus providing such a non-display area, electric power saving is realized. In FIGS. 1(a) and 1(b), reference characters SP1 and SP2 indicate display start positions, while reference characters EP1 and EP2 indicate display end positions.

In the case of a large-sized image display device of 15 inches or larger, the electric power consumption of the LSI used in the device makes up a relatively small proportion of the electric power consumption required for driving the device. In the case of a small-sized image display device for use in small-sized electronic apparatus, on the other hand, the proportion of the electric power consumption of the LSI is relatively large. In recent years, the electric power consumption of the image memory incorporated in the LSI used in an image display device makes up an increasing proportion of the electric power consumption of the LSI. For this reason, it is an important challenge to reduce the electric power consumption of image memory as much as possible by driving the image memory efficiently in accordance with uses and the like by the user.

Conventionally, however, even when a non-display area is provided as described above, it has been necessary to read not only image data for the display area but also image data for the non-display area out of the image memory. Specifically, a system which is configured to read image data items for, for example, one line collectively out of image memory has to read all the image data items for a certain line even when that line contains a non-display area. In this case image data that is not utilized for display is read, which consumes electric power uselessly.

In the case of a mobile telephone or the like, the mobile telephone has to display an image constantly even in the standby state despite the need to ensure sufficient time for the device to operate in the standby state. For this reason, such a mobile telephone has to save electric power while displaying an image without providing a non-display area.

The present invention has been made in view of the foregoing circumstances and it is an object of the present invention to provide an image display device capable of realizing electric power saving and an electronic apparatus incorporating the image display device.

### DISCLOSURE OF INVENTION

In order attain this object, an image display device according to the present invention comprises a display section having a plurality of pixels for image display; and image memory which is operative to store pixel data associated with colors to be displayed by the pixels and which does not need any refreshing operation, the image memory having first memory for storing a predetermined bit of the pixel data and second memory for storing bits of the pixel data other than the predetermined bit, the image display device having an arrangement capable of switching between a first mode in which the predetermined bit is read out of the first memory and the display section is caused to display an image in accordance with the predetermined bit thus read out and a second mode in which the predetermined bit and the bits other than the predetermined bit are read out of the first memory and the second memory, respectively, and the display section is caused to display an image in accordance with the predetermined bit and the bits other than the predetermined bit thus read out.

In the image display device according to the invention, preferably, the pixel data comprises data items indicative of respective gradations of the three primary colors and the predetermined bit of the pixel data comprises a set of respective predetermined bits of the data items indicative of the respective gradations of the three primary colors.

In the image display device according to the invention, preferably, the predetermined bit of the pixel data comprises a set of respective MSBs of the data items indicative of the respective gradations of the three primary colors.

In the first mode of the image display device according to the invention, preferably, the predetermined bit is read out of the first memory and the display section is caused to display the image by a frame rate control exercised in accordance with the predetermined bit thus read out.

Alternatively, in the first mode of the image display device according to the invention, preferably, the predetermined bit is read out of the first memory and the display section is caused to display the image by a duty control based on pulse width modulation in accordance with the predetermined bit thus read out.

An image display device according to the present invention comprises: a display section having a plurality of pixels for image display; and image memory which is operative to store pixel data associated with colors to be displayed by the pixels and which does not need any refreshing operation, the image memory having first memory for storing a predetermined bit of the pixel data and second memory for storing bits of the pixel data other than the predetermined bit, the image display device having an arrangement capable of switching between a first mode in which a predetermined bit of pixel data for a predetermined pixel is read out of the first memory and the display section is caused to display an image in accordance with the predetermined bit thus read out and a second mode in which the predetermined bit and the bits other than the predetermined bit of pixel data for each of the pixels are read out of the first memory and the second memory, respectively, and the display section is caused to display an image in accordance with the predetermined bit and the bits other than the predetermined bit thus read out.

In the image display device according to the invention, preferably, the pixel data comprises data items indicative of respective gradations of the three primary colors and the predetermined bit of the pixel data comprises a set of respective predetermined bits of the data items indicative of the respective gradations of the three primary colors.

In the image display device according to the invention, preferably, the predetermined bit of the pixel data comprises a set of respective MSBs of the data items indicative of the respective gradations of the three primary colors.

Preferably, the image display device according to the invention has an arrangement capable of changing the predetermined pixel in the first mode.

An image display device according to the present invention comprises: a display section having a plurality of pixels for image display, and image memory which is operative to store pixel data associated with colors to be displayed by the pixels and which does not need any refreshing operation, the image memory having first memory for storing a predetermined bit of pixel data for each of the pixels and second memory for storing bits of the pixel data other than the predetermined bit, the image display device having an arrangement capable of switching between a first mode in which: a specific pixel is selected from the plurality of pixels depending on a residual capacity of an electric power supply battery; a predetermined bit of pixel data for the specific pixel thus selected is read out of the first memory or the predetermined bit and the bits other than the predetermined bit of the pixel data for the specific pixel thus selected are read out of the first memory and the second memory, respectively; and the display section is caused to display an image in accordance with the predetermined bit thus read out or in accordance with the predetermined bit and the bits other than the predetermined bits thus read out and a second mode in which: a predetermined bit and bits other than the predetermined bit of pixel data for each of the pixels are read out of the first memory and the second memory, respectively; and the display section is caused to display an image in accordance with the predetermined bit and the bits other than the predetermined bit thus read out.

In the image display device according to the invention, preferably, the pixel data comprises data items indicative of respective gradations of the three primary colors and the predetermined bit of the pixel data comprises a set of respective predetermined bits of the data items indicative of the respective gradations of the three primary colors.

In the image display device according to the invention, preferably, the predetermined bit of the pixel data comprises a set of respective MSBs of the data items indicative of the respective gradations of the three primary colors.

An image display device according to the present invention comprises: a display section having a plurality of pixels for image display; first memory and second memory which are operative to store pixel data associated with colors to be displayed by the pixels and which do not need any refreshing operation; and a control section for switching between a first mode in which pixel data for each of the pixels is written to the first memory and a second mode in which a predetermined bit of the pixel data for each of the pixels is written to the second memory, wherein in the first mode the pixel data for each of the pixels is read out of the first memory and the display section is caused to display an image in accordance with the pixel data thus read out, whereas in the second mode the predetermined bit of the pixel data for each of the pixels is read out of the second memory and the display section is caused to display an image in accordance with the predetermined bit of the pixel data thus read out.

In the image display device according to the invention, preferably, the pixel data comprises data items indicative of respective gradations of the three primary colors and the predetermined bit of the pixel data comprises a set of respective predetermined bits of the data items indicative of the respective gradations of the three primary colors.

In the image display device according to the invention, preferably, the predetermined bit of the pixel data comprises a set of respective MSBs of the data items indicative of the respective gradations of the three primary colors.

An image display device according to the present invention comprises: a display section having a plurality of pixels for image display; first memory which is operative to store a predetermined bit of pixel data associated with colors to be displayed by the pixels and which does not need any refreshing operation; second memory which is operative to store bits of the pixel data other than the predetermined bit and which does not need any refreshing operation; and third memory which is operative to store fixed data having a bit width equal to the bits of the pixel data other than the predetermined bit and which does not need any refreshing operation, the image display device having an arrangement capable of switching between a first mode in which: the predetermined bit and the bits other than the predetermined bit are read out of the first memory and the second memory, respectively; and the display section is caused to display an image in accordance with the predetermined bit and the bits other than the predetermined bit thus read out and a second mode in which: the predetermined bit and the fixed data are read out of the first memory and the third memory, respectively; and the display section is caused to display an image in accordance with the predetermined bit and the fixed data thus read out.

In the image display device according to the invention, preferably, the pixel data comprises data items indicative of respective gradations of the three primary colors and the predetermined bit of the pixel data comprises a set of respective predetermined bits of the data items indicative of the respective gradations of the three primary colors.

In the image display device according to the invention, preferably, the predetermined bit of the pixel data comprises a set of respective MSBs of the data items indicative of the respective gradations of the three primary colors.

Preferably, the image display device according to the invention has an arrangement capable of changing the fixed data.

An electronic apparatus according to the present invention comprises: an image display device as recited in claim 1; and an arrangement for outputting pixel data to the image display device.

The foregoing and other objects, features and advantages of the present invention will become apparent from the following detailed description of the preferred embodiments with reference to the accompanying drawings.

### BRIEF DESCRIPTION OF DRAWINGS

FIG. 1 is a view illustrating display states of a conventional display device.

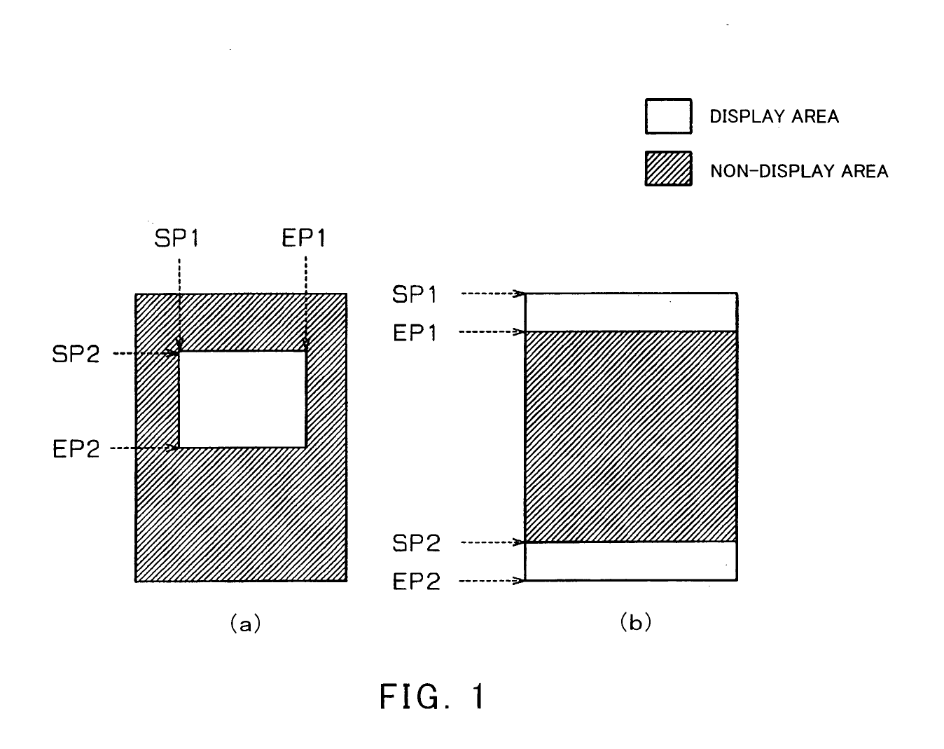

FIG. 2 is a block diagram illustrating the configuration of an image display device according to embodiment 1 of the present invention.

FIG. 3 is a view illustrating the outward appearance of a mobile telephone provided with the image display device according to embodiment 1 of the present invention as a display section.

FIG. 4 is a conceptual illustration of an arrangement of image memory included in the image display device according to embodiment 1 of the present invention; specifically, FIG. 4(a) is an illustration of the arrangement of the image memory in connection with pixels of the display section, while FIG. 4(b) is an illustration of the arrangement of the image memory in terms of a three-dimensional coordinate system.

FIG. 5 is a schematic diagram illustrating a specific example of an arrangement of the image memory included in the image display device according to embodiment 1 of the present invention.

FIG. 6 is a diagram illustrating an example of a detailed arrangement of the image memory shown in FIG. 5.

FIG. 7 is a diagram illustrating an arrangement of image memory for reading/writing higher-order M bits and lower-order (N-M) bits of pixel data separately.

FIG. 8 is a schematic diagram illustrating another specific example of an arrangement of the image memory included in the image display device according to embodiment 1 of the present invention.

FIG. 9 is a schematic diagram illustrating yet another specific example of an arrangement of the image memory included in the image display device according to embodiment 1 of the present invention.

FIG. 10 is a conceptual illustration of an arrangement of image memory included in an image display device according to embodiment 2 of the present invention in terms of a three-dimensional coordinate system.

FIG. 11 is a conceptual illustration of display areas and non-display areas of the image display device according to embodiment 2 of the present invention; specifically, FIGS. 11(a) to 11(c) are illustrations of the display areas and the non-display areas in an electric power saving mode.

FIG. 12 is a block diagram illustrating the configuration of an image display device according to embodiment 3 of the present invention.

FIG. 13 illustrates display processing in the image display device according to embodiment 3 of the present invention; specifically, FIG. 13(a) is an illustration of an example of correspondence between residual capacity levels of a battery and operations of switches, while FIG. 13(b) is an illustration of an example of correspondence between residual capacity levels of the battery and display patterns.

FIG. 14 is a block diagram illustrating the configuration of an image display device according to embodiment 4 of the present invention.

FIG. 15 illustrates the configuration of an image display device according to embodiment 5 of the present invention; specifically, FIG. 15(a) is a block diagram illustrating the configuration, while FIG. 15(b) is a diagram illustrating a computation on pixel data performed in the image display device.

FIG. 16 illustrates the configuration of an image display device according to embodiment 6 of the present invention; specifically, FIG. 16(a) is a block diagram illustrating the configuration, while FIG. 16(b) is a diagram illustrating a computation on pixel data performed in the image display device.

### BEST MODE FOR CARRYING OUT THE INVENTION

Hereinafter, embodiments of the present invention will be described in detail with reference to the drawings.

Embodiment 1

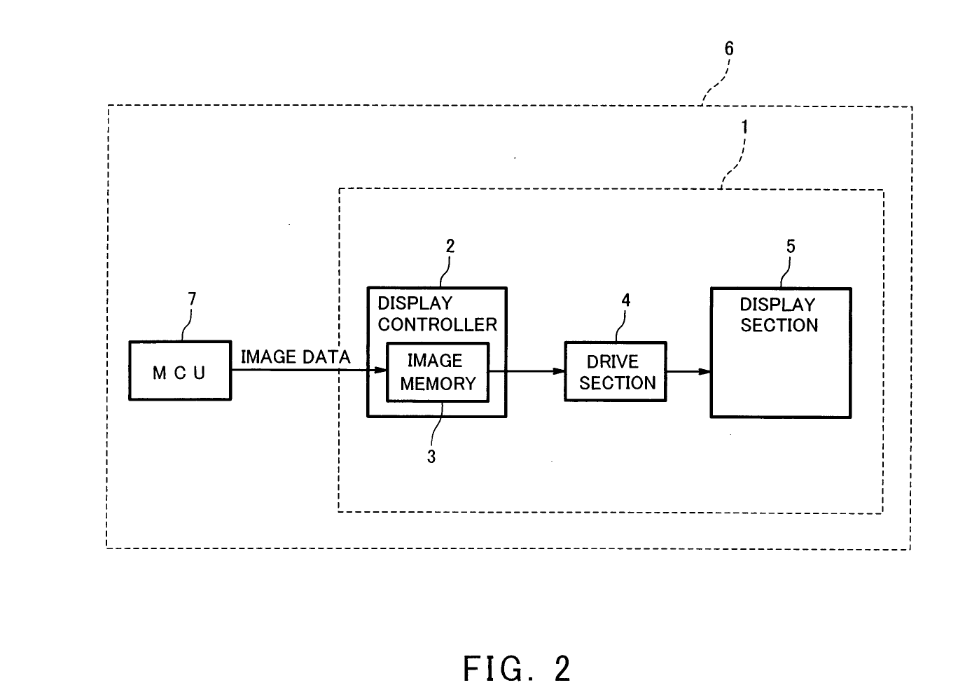

FIG. 2 is a block diagram illustrating the configuration of an image display device according to embodiment 1 of the present invention. As shown in FIG. 2, image display device 1 includes image memory 3 for storing image data, a display controller 3 which has image memory 3 and which is operative to control reading/writing from and to image memory 3, a display section 5 having a plurality of pixels for image display, and a drive section 4 for driving the display section 5 based on image data stored in the image memory 3 in accordance with instructions given from the display controller 2. Here, image memory 3 comprises SRAM (Static Random Access Memory), which is capable of holding stored data without any refreshing operation. The display section 5 is a display panel comprising a liquid crystal display device, an organic/inorganic electroluminescence (EL) device or the like.

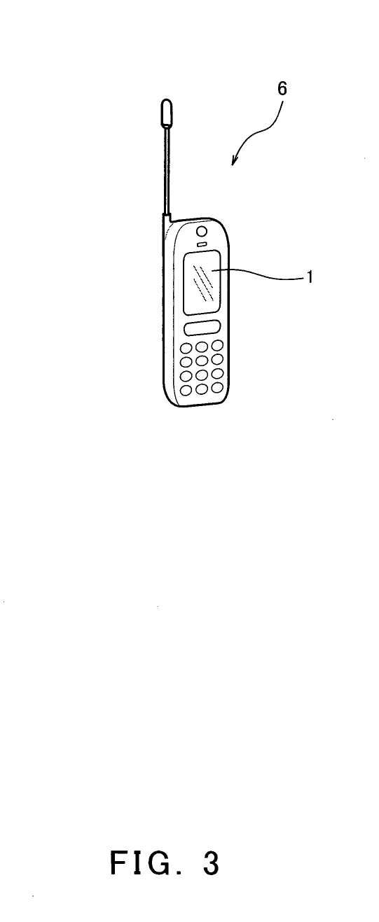

The image display device 1 is provided in an electronic apparatus 6 of a relatively small size such as a mobile telephone or a PDA (Personal Digital Assistant). The electronic apparatus 6 has a microcomputer (MCU) 7 for outputting image data on a color image to the display controller 2 of the image display device 1. FIG. 3 is a view illustrating the outward appearance of mobile telephone 6 provided with the image display device 1 according to embodiment 1 of the present invention as a display section.

Image memory 3 mentioned above is configured to be capable of storing image data in an amount corresponding to one field of the display section 5. Hereinafter, image data for each of the pixels will be referred to as “pixel data”. Here, the pixel data comprises data items indicative of respective gradations of red, green and blue. For example, when the gradation of each of red, green and blue is expressed with 8 levels of gradation, the pixel data has a bit width of 24 (8 bits×3). In this case it is possible to display 16,777,216 (=2⁸×2⁸×2⁸) colors.

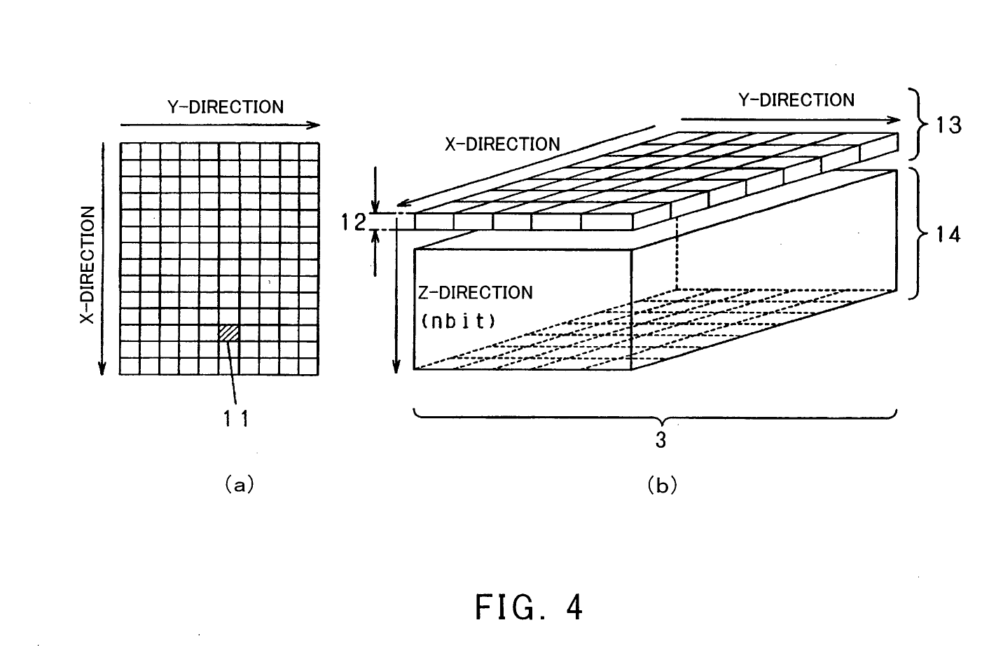

FIG. 4 is a conceptual illustration of an arrangement of the image memory included in the image display device according to embodiment 1 of the present invention; specifically, FIG. 4(a) is an illustration of the arrangement of the image memory in connection with the pixels of the display section, while FIG. 4(b) is an illustration of the arrangement of the image memory in terms of a three-dimensional coordinate system.

As shown in FIGS. 4(a) and 4(b), image memory 3 has portions arranged in the X-direction and the Y-direction so that the number of these portions is equal to the number of the pixels provided and is capable of storing pixel data items 11 having an information content of n bits in the Z-direction for all the pixels provided. Image memory 3 thus arranged is divided into two regions in the Z-direction and comprises MSB division memory 13 capable of storing only MSB (Most Significant Bit) data 12 of each pixel data item 11 and lower-order bit division memory 14 capable of storing lower-order bit data other than the MSB data 12. As described above, the pixel data comprises data items indicative of respective gradations of red, green and blue. Therefore, the MSB data to be stored in the MSB division memory 13 is a set of MSBs of the data items indicative of the respective gradations of red, green and blue. Accordingly, the bit width of the MSB data is 3. The lower-order bit data is a set of bits of the data items indicative of the respective gradations of red, green and blue other than the MSBs.

As will be described later, when the electronic apparatus 6 is in a normal use state, the display controller 2 functions to drive image memory 3 entirely to display an image, whereas when the electronic apparatus 6 is in a standby state, the display controller 2 operates in an electric power saving mode to drive only MSB division memory 13 of image memory 3 for image display. Accordingly, the display controller 2 fails to drive lower-order bit division memory 14 in the electric power saving mode. In this way a reduction in electric power consumption can be achieved.

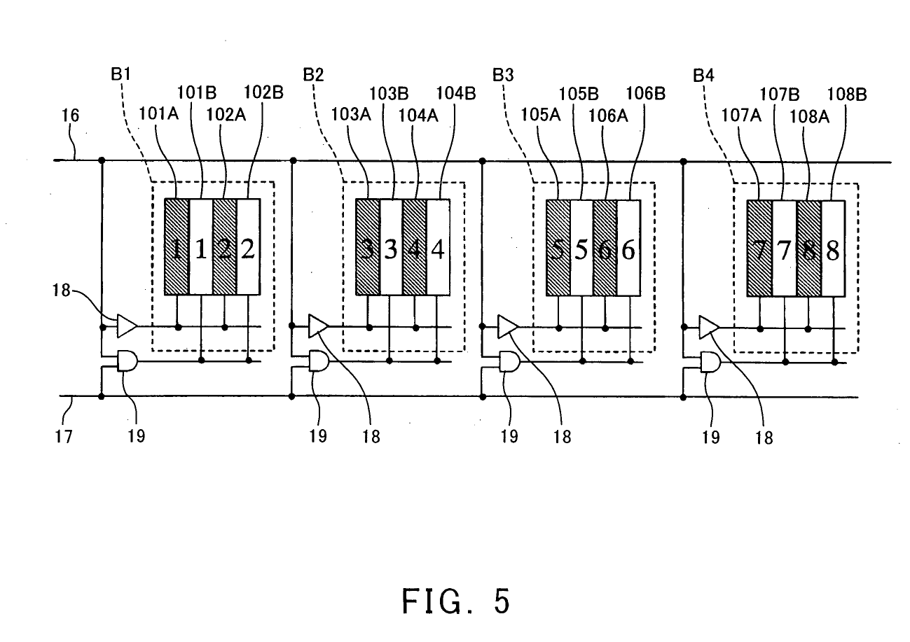

FIG. 5 is a schematic diagram illustrating a specific example of an arrangement of the image memory included in the image display device according to embodiment 1 of the present invention. Hereinafter, the pixels included in the display section 5 will be referred to as first pixel, second pixel, third pixel, . . . for distinction from each other.

In FIG. 5, memory cells 101A and 101B and memory cells 102A and 102B are storage areas for storing pixel data for the first pixel and pixel data for the second pixel, respectively. These memory cells 101A, 101B, 102A and 102B are controlled as a bank B1. Since the arrangement of memory cells 103A, 103B, 104A and 104B and the succeeding memory cells are the same as the arrangement of memory cells 101A, 101B, 102A and 102B, description thereof will be omitted.

The memory cells 101A and 102A are connected to a word line 16 via a word line buffer 18. Here, the word line 16 is a control line for selecting memory cells arranged adjacent to each other along the line (in the lateral direction) simultaneously. On the other hand, the memory cells 101B and 102B are connected to the word line 16 and a signal line 17 via a gradation selecting signal generator 19 for generating a gradation selecting signal to be described later.

When a signal corresponding to a predetermined voltage is outputted to the word line 16 of image memory 3 thus arranged, the signal is inputted to the memory cells 101A, 102A, . . . after temporary storage at the word line buffer 18. As a result, the gate circuits (not shown) of the memory cells 101A, 102A, . . . are turned on to read/write the MSB data of pixel data from and to the memory cells 101A, 102A, . . . through bit line (not shown).

When a signal corresponding to a predetermined voltage is outputted to the signal line 17 while a signal corresponding to a predetermined voltage outputted to the word line 16 similarly to the aforementioned case, these signals are inputted to the gradation selecting signal generator 19. As a result, the gradation selecting signal generator 19 generates a gradation selecting signal indicating that the lower-order bit data is to be utilized in image display and then the gradation selecting signal is inputted to the memory cells 101B, 102B, . . . . This causes the gate circuits (not shown) of the memory cells 101B, 102B, . . . to turn on so that the lower-order bit data of pixel data is read/written from and to the memory cells 101B, 102B, . . . through bit line (not shown).

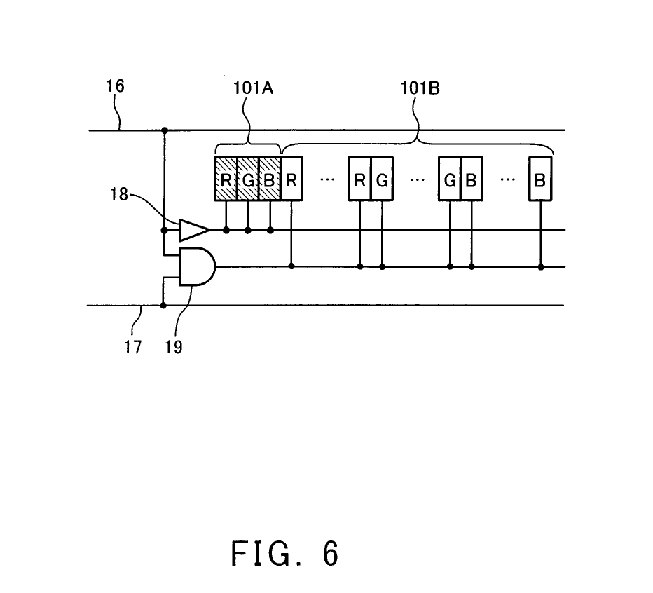

As described earlier, the MSB data to be read/written from and to the memory cell 101A is a set of MSBs of data items indicative of respective gradations of red, green and blue. On the other hand, the lower-order bit data to be read/written from and to the memory cell 101B is a set of bits of the data items indicative of the respective gradations of red, green and blue other than the MSBs. Accordingly, the details of the memory cells 101A and 101B are as shown in FIG. 6.

Thus, the memory cells 101A, 102A, . . . and the memory cells 101B, 102B, . . . are storage areas for reading/writing of the MSB data and the lower-order bit data, respectively, of pixel data. Therefore, the memory cells 101A, 102A, . . . and the memory cells 101B, 102B, . . . correspond to MSB division memory 13 and lower-order bit division memory 14, respectively.

With reference to FIGS. 2 and 5, description will be made of the operation of the image display device according to embodiment 1 of the present invention. When the electronic apparatus 6 is in the normal use state, MCU 7 outputs image data (pixel data for all the pixels) to the display controller 2 of the image display device 1 while instructing the display controller 2 to display an image in the normal mode. Upon receipt of this instruction, the display controller 2 outputs signals corresponding to respective predetermined voltages to the word line 16 and the signal line 17, respectively, thereby driving the memory cells 101A, 102A, . . . and the memory cells 101B, 102B, . . . . Then, the display controller 2 writes the MSB data and lower-order bit data of pixel data to the memory cells 101A, 102A, . . . and the memory cells 101B, 102B, . . . , respectively. In this way the MSB data and the lower-order bit data are stored in the memory cells 101A, 102A, . . . and the memory cells 101B, 102B, . . . , respectively.

Subsequently, the display controller 2 reads the MSB data and the lower-order bit data, which are stored in the memory cells 101A, 102A, . . . and the memory cells 101B, 102B, . . . , respectively, with predetermined timing and outputs them to the drive section 4. The drive section 4, in turn, causes the display section 5 to display an image in accordance with the MSB data and lower-order bit data inputted to the drive section 4. As a result, an image corresponding to the image data outputted from the MCU 7 is displayed in the display section 5. For example, when each pixel data item has a bit width of 24 and hence is capable of developing 16,777,216 colors, the display section 5 is capable of displaying 16,777,216 colors in the normal mode.

When the electronic apparatus 6 is in the standby state, on the other hand, the MCU 7 outputs image data to the display controller 2 of the image display device 1 while instructing the display controller 2 to display an image in the electric power saving mode. Upon receipt of this instruction, the display controller 2 outputs a signal corresponding to a predetermined voltage to the word line 16 only. As a result, only the memory cells 101A, 102A, . . . are driven, whereas the memory cells 101B, 102B, . . . remain undriven. When rewriting of image data is necessary, the display controller 2 writes the MSB data of pixel data to the memory cells 101A, 102A, . . . . In this way the MSB data is stored in the memory cells 101A, 102A, . . . .

Subsequently, the display controller 2 reads the MSB data stored in the memory cells 101A, 102A, . . . with predetermined timing and then outputs it to the drive section 4. The drive section 4, in turn, causes the display section 5 to display an image in accordance with the MSB data inputted. As a result, an image corresponding to the MSB data is displayed in the display section 5. Since the MSB data has a bit width of 3 in this case, the MSB data can develop 8 (2³) colors. Accordingly, only 8 colors can be displayed in the electric power saving mode.

Thus, the memory cells 101B, 102B, . . . remain undriven in the electric power saving mode and, hence, a great reduction in electric power consumption can be realized. Though the electric power saving mode allows only 8 colors to be displayed, there arise no particular problems because in most cases full color display is unnecessary for the electronic apparatus 6 in the standby state.

In the electric power saving mode the display controller 2 can operate so as to allow a minimum required number of colors to be displayed by exercising a frame rate control or a duty control based on pulse width modulation (PWM) utilizing the MSB data of pixel data for each pixel.

If the memory cells 101A, 102A, . . . are arranged to allow reading/writing of data on some higher-order bits of each pixel data item, 8 or more colors can be displayed even in the electric power saving mode.

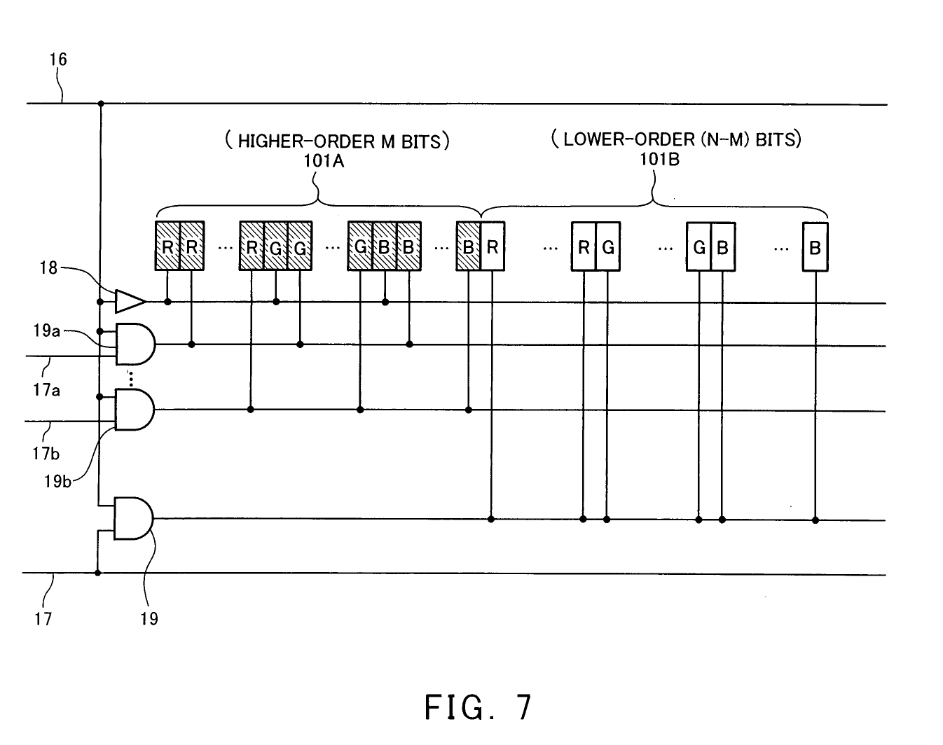

For example, where the bit width of pixel data is N (N is a positive integer), an arrangement can be employed such that the memory cells 101A, 102A, . . . allow reading/writing of higher-order M (M is a positive integer, N>M) bits of each pixel data item while the memory cells 101B, 102B, . . . allow reading/writing of lower-order (N−M) bits of each pixel data item. The details of memory cells 101A and 101B in this arrangement are as shown in FIG. 7. Portions of memory cell 101A for storing MSBs of higher-order M bits are connected to word line 16 via word line buffer 18, as shown in FIG. 7. On the other hand, portions of memory cell 101A for storing bits of the higher-order M bits other than the MSBs are connected to word line 16 and signal lines 17a, 17b, . . . via gradation selecting signal generators 19a, 19b, . . . .

When a signal corresponding to a predetermined voltage is outputted to the word line 16 of image memory 3 thus arranged, the signal is inputted to the portions of memory cell 100A for storing the MSBs after temporary storage at the word line buffer 18, thus driving those portions of memory cell 101A.

When signals corresponding to respective predetermined voltages are outputted to the signal lines 17a, 17b, . . . , while a signal corresponding to a predetermined voltage outputted to the word line 16 similarly to the above, the signals are respectively inputted to the gradation selecting signal generators 19a, 19b, . . . . As a result, the gradation selecting signal generator 19 generates gradation selecting signals each indicating that the bits of higher-order M bits other than the MSB are to be utilized in image display. Then, the gradation selecting signals are inputted to the portions of memory cell 101A for storing the bits of higher-order M bits other than MSBs, thus driving those portions of memory cell 101A.

For example, assume that the bit width of each of data items indicative of respective gradations of red, green and blue is 8, M is 4 and the 2 bits of higher-order 4 bits, namely the MSB and the bit succeeding the MSB, are to be read/written from and to memory cell 101A. In this case the aforementioned signals are respectively outputted to the word line 16 and to only the signal line 17a of the signal lines. Thus, a gradation selecting signal is generated only by the gradation selecting signal generator 19a of the gradation selecting signal generators 19a, 19b, . . . . As a result, only the portions of memory cell 101A corresponding to the two bits, namely the MSB and the bit succeeding the MSB, are driven.

In this case, the bit width N of pixel data is 24 (8 bits×3) and the bit width of higher-order bit data (a set of respective higher-order two bits of data items indicative of respective gradations of red, green and blue) is 6 (2 bits×3). Accordingly, 64 (=2²×2²×2²) colors can be displayed in the electric power saving mode.

If an arrangement is employed such that only the portions of memory cell 101A corresponding to 4 bits are driven in the same manner as described earlier, the bit width of higher-order bit data (a set of respective higher-order 4 bits of data items indicative of respective gradations of red, green and blue) to be read/written from and to memory cell 101A is 12 (4 bits×3). Accordingly, 4096 (=2⁴×2⁴×2⁴) colors can be displayed in the electric power saving mode.

Though the bit width M of higher-order bit data to be read/written from and to each of the memory cells 101A, 102A, . . . is 4 in the example described above, it is needless to say that any value other than 4 may also be used. The number of displayable colors in the electric power saving mode can be adjusted by adjusting the number of bits within M to be read/written from and to each of the memory cells 101A, 102A, . . . . Therefore, the number of displayable colors can be established stepwise by providing several levels of electric power saving mode and setting bit widths within the bit width M that are to be read/written from and to each of the memory cells 101A, 102A, . . . to desired values in accordance with the levels provided.

It is to be noted that switching from the normal mode to the electric power saving mode may be made either automatically as the electronic apparatus 6 switches from the normal use state to the standby state or in accordance with the user's instruction.

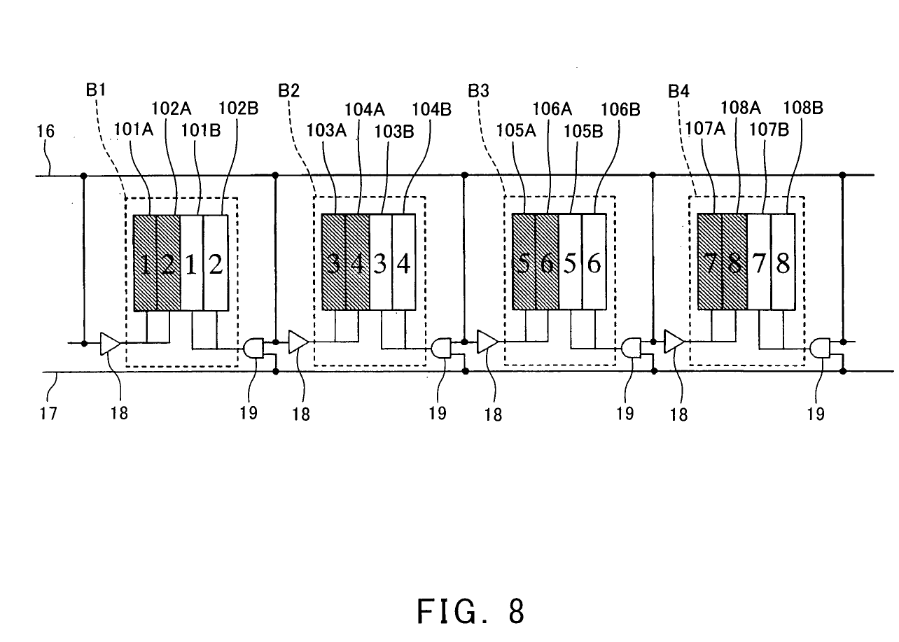

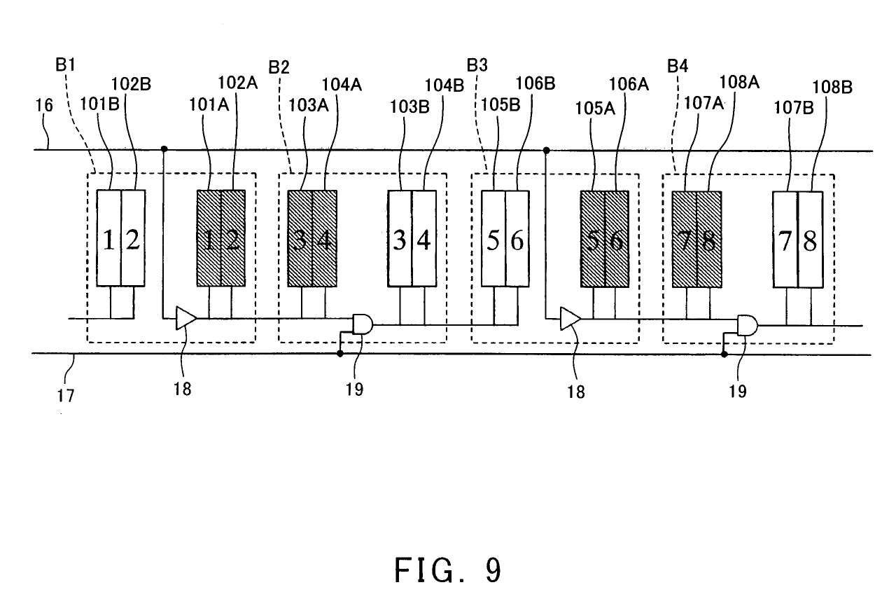

Meanwhile, the word line buffers 18 and the gradation selecting signal generators 19 are provided on respective two stages in FIG. 5. However, there is no limitation to such an arrangement, and arrangements shown in FIGS. 8 and 9 are possible.

In the arrangement shown in FIG. 8 where memory cells 101A, 102A, . . . for storing MSB data are arranged adjacent to each other and memory cells 101B, 102B, . . . for storing lower-order bit data arranged adjacent to each other in each of banks B1, B2, . . . , the word line buffers 18 and the gradation selecting signal generators 19 can provided on a single stage. As a result, image memory 3 can be arranged more compactly than in the case where the memory cells are arranged as shown in FIG. 5.

Alternatively, in the arrangement shown in FIG. 9 where memory cells 101A, 102A, . . . for storing MSB data are arranged adjacent to each other and memory cells 101B, 102B, . . . for storing lower-order bit data arranged adjacent to each other in each of banks B1, B2, . . . while, at the same time, memory cell groups for storing MSB data (for example, a memory cell group consisting of memory cells 101A and 102A and a memory cell group consisting of memory cells 103A and 104A) are arranged adjacent to each other and memory cell groups for storing lower-order bit data (for example, a memory cell group consisting of memory cells 103B and 104B and a memory cell group consisting of memory cells 105B and 106B) arranged adjacent to each other in each pair of adjacent banks, two banks can share one word line buffer 18 and one gradation selecting signal generator 19. As a result, image memory 3 can be realized with reduced cost as compared to the case where the memory cells are arranged as shown in FIG. 5 and FIG. 8.

Embodiment 2

The image memory included in the image display device according to embodiment 1 is divided into two regions in the Z-direction, as shown in FIG. 4. In contrast, image memory included in an image display device according to embodiment 2 is divided into several regions not only in the Z-direction but also in the X-direction and/or the Y-direction. The configuration of the image display device according to embodiment 2 is the same as that of the image display device according to embodiment 1 except image memory. Therefore, the following description will be directed only to the arrangement of image memory included in the image display device according to embodiment 2.

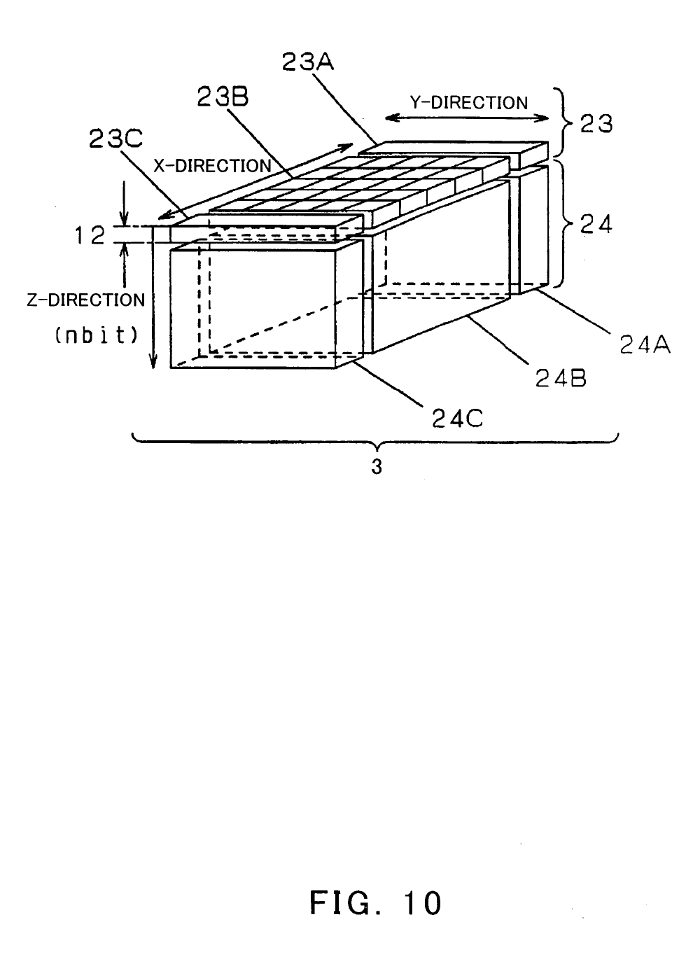

FIG. 10 is a conceptual illustration of the arrangement of image memory included in the image display device according to embodiment 2 of the present invention in terms of a three-dimensional coordinate system. As shown in FIG. 10, image memory 3 included in the image display device according this embodiment has portions arranged in the X-direction and the Y-direction so that the number of these portions is equal to the number of the pixels provided and is capable of storing pixel data items having an information content of n bits in the Z-direction. Image memory 3 thus arranged is divided into two regions in the Z-direction and comprises MSB division memory 23 capable of storing only MSB data 12 of each pixel data item 11 and lower-order bit division memory 24 capable of storing lower-order bit data other than the MSB data 12. Further, MSB division memory 24 is divided into MSB division memory portions 23A, 23B and 23C in the X-direction. Also, lower-order bit division memory 24 is divided into lower-order bit division memory portions 24A, 24B and 24C in the X-direction. Here, MSB division memory 23 and lower-order bit division memory 24 are divided at common points in the X-direction.

In the normal mode the image display device according to this embodiment including image memory 3 thus arranged reads/writes image data by driving image memory 3 entirely as in embodiment 1. As a result, an image corresponding to the image data is displayed in the display section. In the electric power saving mode, on the other hand, the image display device drives only MSB division memory 23 as in embodiment 1 with, for example, the MSB division memory portions 23A and 23C driven and the MSB division memory portion 23B undriven. As a result, reading/writing of image data is not made from and to the MSB division memory portion 23B, which results in the provision of a non-display area corresponding to the MSB division memory portion 23B. The aforementioned Japanese Patent Laid-Open Publication No. HEI 11-184434 establishes a non-display area in the driving circuit of the display device, whereas this embodiment forms a non-display area by providing a non-use area in memory for storing image data. In this way a further reduction in electric power consumption than in embodiment 1 can be achieved.

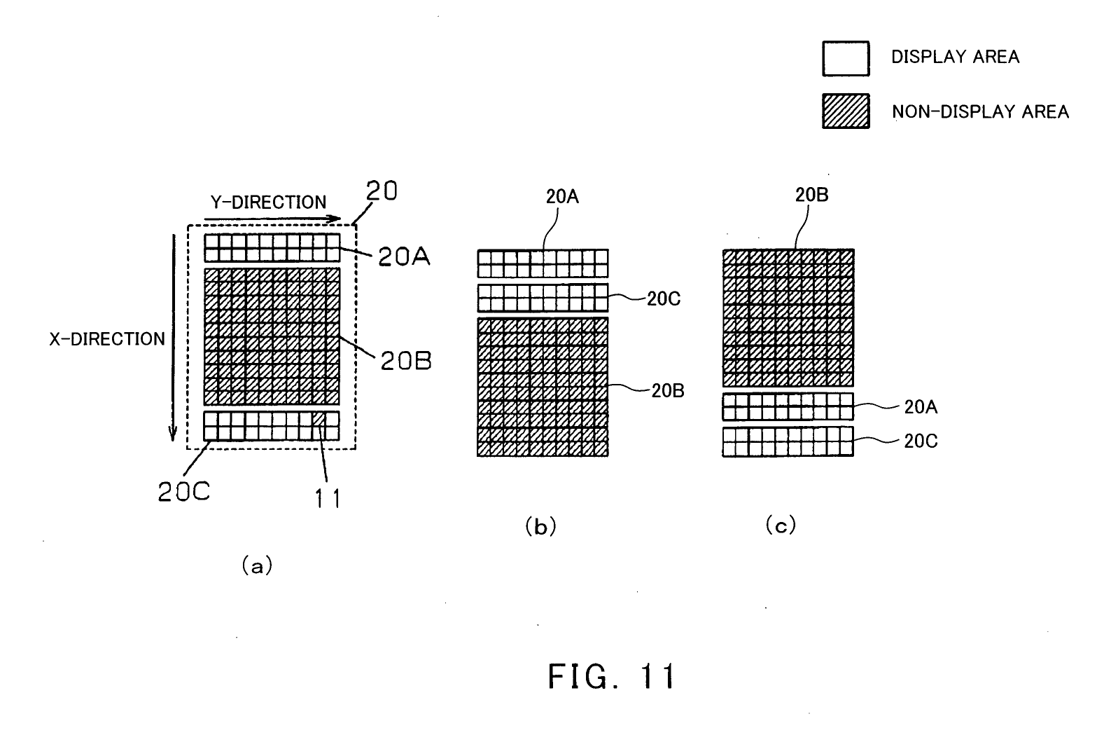

FIG. 11 is a conceptual illustration of display areas and non-display areas of the image display device according to embodiment 2 of the present invention; specifically, FIGS. 11(a) to 11(c) are illustrations of the display areas and the non-display areas in the electric power saving mode. As shown in FIG. 11(a), display screen 20 comprises areas 20A, 20B and 20C. Here, the areas 20A, 20B and 20C correspond to the combination of the MSB division memory portion 23A and the lower-order bit division memory portion 24A, the combination of the MSB division memory portion 23B and the lower-order bit division memory portion 24B and the combination of the MSB division memory portion 23C and the lower-order bit division memory portion 24C, respectively, in FIG. 10.

FIG. 11(a) illustrates the display area and non-display areas of the display screen 20 in the electric power saving mode in which only the MSB division memory portions 23A and 23C are driven while the MSB division memory portion 23B halted. It is to be noted that the lower-order bit division memory portions 24A, 24B and 24C are not driven in the electric power saving mode.

As shown in FIG. 11(a), when the MSB division memory portion 23B is halted, only the areas 20A and 20C become display areas while the area 20B becomes a non-display area. In this case the positions of the display areas 20A and 20C on the display screen 20 can be moved by changing the sequence of MSB data reading from the MSB division memory portions 23A and 23C (see FIGS. 11(b) and 11(c).) Accordingly, the display areas 20A and 20C for example can be moved at predetermined time intervals. By so doing, the so-called “burn” can be avoided.

While MSB division memory 23 and lower-order bit division memory 24 of this embodiment are divided into three in the X-direction, it is needless to say that they may be divided into two or four or more. Also, MSB division memory 23 and lower-order bit division memory 24 may be divided into several regions in the Y-direction.

As the need arises, the number of displayable colors is increased virtually by a frame rate control or a duty control based on PWM. Also, as described in embodiment 1, the MSB division memory portions 23A, 23B and 23C may be arranged to enable reading/writing of data on some of higher-order bits of each pixel data item. Such an arrangement makes it possible to adjust the number of displayable colors.

Embodiment 3

An image display device according to embodiment 3 is configured to switch between the normal mode and the electric power saving mode in accordance with the residual capacity of a battery supplying electric power to the image display device.

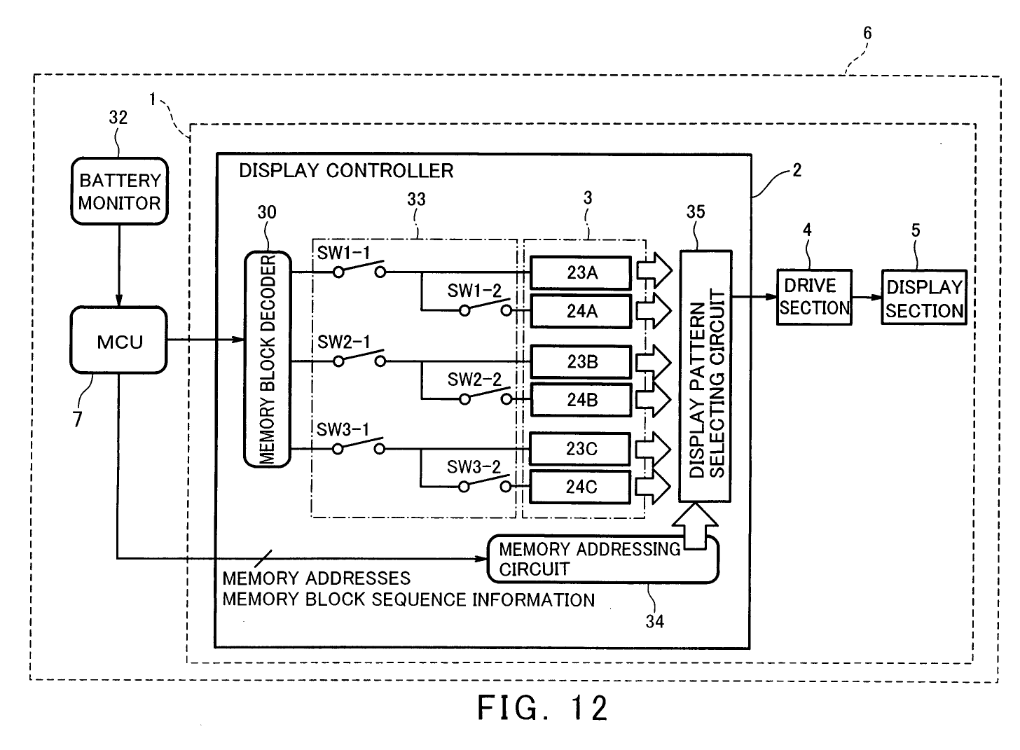

FIG. 12 is a block diagram illustrating the configuration of the image display device according to embodiment 3 of the present invention. As illustrated in FIG. 12, display controller 2 included in image display device 1 according to this embodiment has a switch group 33, a memory block decoder 30 for operating the switch group 33 in accordance with instructions from MCU 7, image memory 3, a memory addressing circuit 34, and a display pattern selecting circuit 35. Here, image memory 3 comprises MSB division memory portions 23A, 23B and 23C and lower-order bit division memory portions 24A, 24B and 24C, like the image memory included in the image display device according to embodiment 2 (see FIG. 10.) Since other features of the image display device 1 according to embodiment 3 are similar to the corresponding features of the image display device according to embodiment 1, like reference numerals are used to designate such features in order to omit description thereof.

A battery monitor 32 provided in electronic apparatus 6 monitors the residual capacity of the battery (not shown) used in the electronic apparatus 6. When MCU 7 receives information indicative of the residual capacity of the battery from the battery monitor 32, MCU 7 outputs combination information indicative of an ON/OFF combination of the switch group 33 to the memory block decoder 30 so as to operate the switch group 33 in accordance with the information received. Further, MCU 7 outputs memory addresses and memory block sequence information indicative of a sequence of image data reading out of memory blocks of image memory 3 to the memory addressing circuit 34.

The memory block decoder 30 operates switches SW1-1, SW2-1, SW3-1, SW1-2, SW2-2 and SW3-2 belonging to the switch group 33 in accordance with the combination information received from MCU 7. The MSB division memory portions 23A, 23B and 23C and the lower-order bit division memory portions 24A, 24B and 24C are driven in accordance with operations of the switch group 33. As a result, image data is written to some of the division memory portions.

The memory addressing circuit 34 outputs memory block sequence information to the display pattern selecting circuit 35. The display pattern selecting circuit 35, in turn, reads image data out of those division memory portions of the MSB division memory portions 23A, 23B and 23C and lower-order bit division memory portions 24A, 24B and 24C to which the image data has been written in accordance with the memory block sequence information and then outputs the image data thus read to the drive section 4. As a result, the drive section 4 drives the display section 5 in accordance with the image data received from the display pattern selecting circuit 35, so that an image corresponding to the image data is displayed in the display section 5.

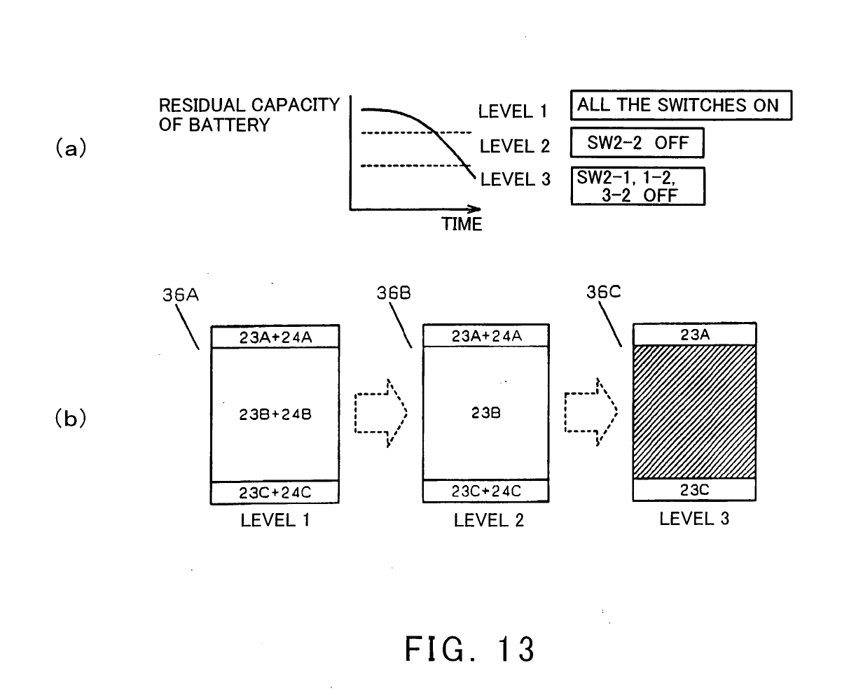

FIG. 13 illustrates display processing in the image display device according to embodiment 3 of the present invention; specifically, FIG. 13(a) is an illustration of an example of correspondence between residual capacity levels of the battery and operations of the switch group, while FIG. 13(b) is an illustration of an example of correspondence between residual capacity levels of the battery and display patterns.

As shown in FIG. 13(a), the residual capacity of the battery included in the electronic apparatus 6 is divided into three ranges, which are referred to as levels 1, 2 and 3 in a descending order from the highest residual capacity. The correspondence between each of the levels and an ON/OFF operation of the switch group 33 is predetermined. FIG. 13(a) illustrates an exemplary case where: all the switches of the switch group 33 are turned on when the residual capacity of the battery assumes level 1; only switch SW2-2 is turned off when the residual capacity assumes level 2; and further, switches SW2-1, SW1-2 and SW3-2 are turned off when the residual capacity of the battery assumes level 3.

When the residual capacity levels of the battery correspond to operations of the switch group as shown in FIG. 13(a), different display patterns results in accordance with the residual capacity levels of the battery, as shown in FIG. 13(b). First, since all the switches of the switch group 33 are turned on at level 1, the MSB division memory portions 23A, 23B and 23C and the lower-order bit division memory portions 24A, 24B and 24C are all driven, so that image data is read/written to provide a display pattern 36A. At level 2, the switch SW2-2 is turned off and, accordingly, the MSB division memory portions 23A, 23B and 23C and the lower-order bit division memory portions 24A and 24C except the lower-order bit division memory portion 24B are driven for reading/writing of image data. At level 3, the switches SW2-1, SW1-2 and SW3-2, further, are turned off and, accordingly, only the MSB division memory portions 23A and 23C are driven for reading/writing of image data. Thus, the number of division memory portions to be driven at level 2 or level 3 is decreased and, hence, the electric power consumption can be reduced as compared with that required at level 1. Therefore, it is possible to delay the decrease in the residual capacity of the battery.

As a result of display processing performed as described above, a full color image is displayed at level 1, whereas the number of colors displayed at level 2 or level 3 is decreased. For this reason, a frame rate control or a duty control based on PWM may be performed to increase the number of displayable colors virtually, as the need arises. As already described in embodiment 1, the MSB division memory portions 23A, 23B and 23C may be arranged to enable reading/writing of not MSB data but data on some of higher-order bits of each pixel data item. Such an arrangement will make it possible to adjust the number of displayable colors at each level.

It is needless to say that the correspondence between the residual capacity levels of the battery and the operations of the switch group 33 is not limited to the example illustrated in FIG. 13(a). An arrangement may be employed such as to allow the user to establish the correspondence between residual capacity levels of the battery and operations of the switch group 33 as desired.

Embodiment 4

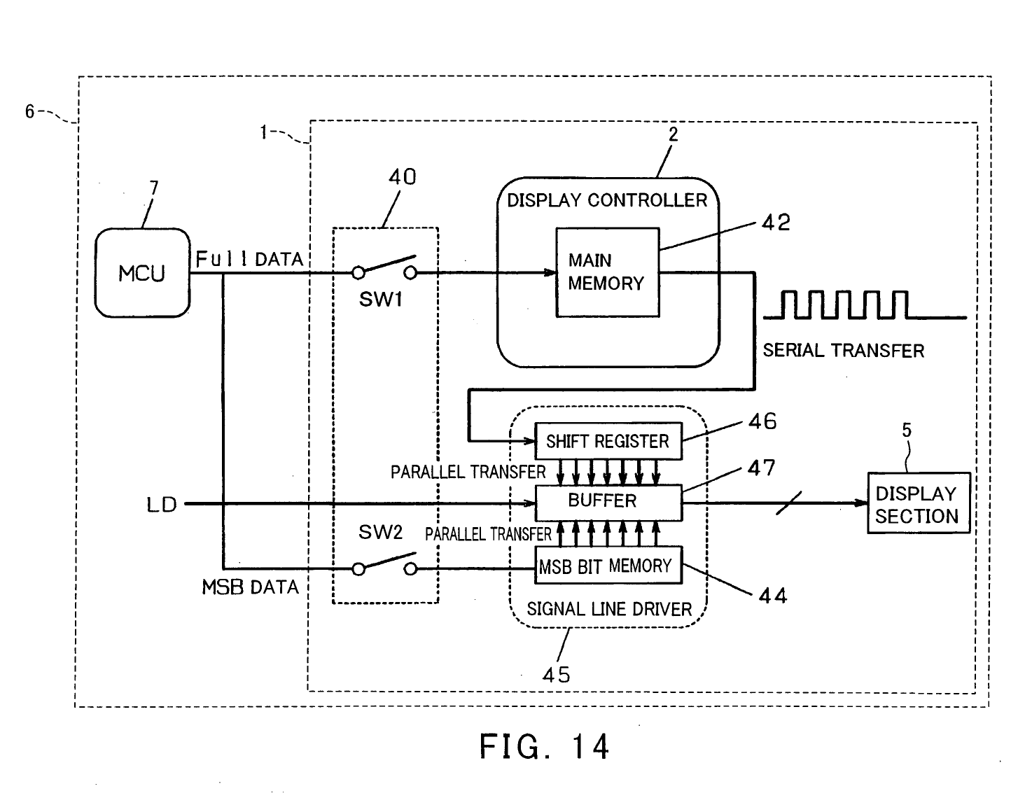

FIG. 14 is a block diagram illustrating the configuration of an image display device according to embodiment 4 of the present invention. As shown in FIG. 14, image display device 1 according to this embodiment includes a switch group 40, main memory 42 for storing image data, a display controller 2 which has the main memory 42 and controls reading/writing from and to the main memory 42, a display section 5, and a signal line driver 45 for driving signal lines provided in the display section 5. Here, main memory comprises SRAM, which is capable of holding stored contents without any refreshing operation.

The signal line driver 45 mentioned above includes a shift register 46, a buffer 47, and MSB bit memory 44. Here, MSB bit memory 44 is adapted to store MSB data (a set of MSBs of pixel data items indicative of respective gradations of red, green and blue) to be inputted from MCU 7 included in electronic apparatus 6.

It is to be noted that a single port RAM is often used for main memory 42 included in the display controller 2 from the viewpoints of cost and mounting area. For this reason, reading/writing from and to main memory 42 is performed in a complete time-sharing manner, and data is serially transferred in data reading.

When the electronic apparatus 6 is in the normal use state, MCU 7 turns switches SW1 and SW2 of the switch group 40 on and off, respectively, so that image data for all the pixels (Full data in FIG. 14) can be outputted to the display controller 2. The display controller 2, in turn, writes Full data inputted from MCU 7 to main memory 42. Further, the display controller 2 reads Full data out of main memory 42 with predetermined timing and serially transfers the Full data thus read to the signal line driver 45.

The Full data thus serially transferred is serial/parallel converted at the shift register 46 and then parallel-transferred to the buffer 47. After the buffer 47 latches Full data in an amount corresponding to one horizontal period, the Full data latched is outputted to the display section 5 in accordance with an LD signal.

When the electronic apparatus 6 is in the standby state, on the other hand, MCU 7 turns switches SW1 and SW2 off and on, respectively, so that MSB data can be outputted to the signal line driver 45. The signal line driver 45, in turn, drives MSB bit memory 44 so that the MSB data inputted from MCU 7 is written to MSB bit memory 44. The MSB data thus written is parallel-transferred to the buffer 47. After the buffer 47 latches MSB data in an amount corresponding to one horizontal period, the MSB data latched is outputted to the display section 5 in accordance with an LD signal.

By employing such an arrangement wherein the signal line driver 45 is provided with MSB bit memory 44 having a smaller capacity than main memory 42 and only MSB bit memory 44 is driven for reading/writing of image data in the standby state of the electronic apparatus 6, a reduction in electric power consumption can be realized.

It is needless to say that a frame rate control or a duty control based on PWM may be performed to increase the number of displayable colors virtually as the need arises.

As described in embodiment 1, MSB bit memory 44 may have an arrangement such as to enable reading/writing of not MSB data but data on some of higher-order bits of each pixel data item. Such an arrangement will make it possible to adjust the number of displayable colors.

Embodiment 5

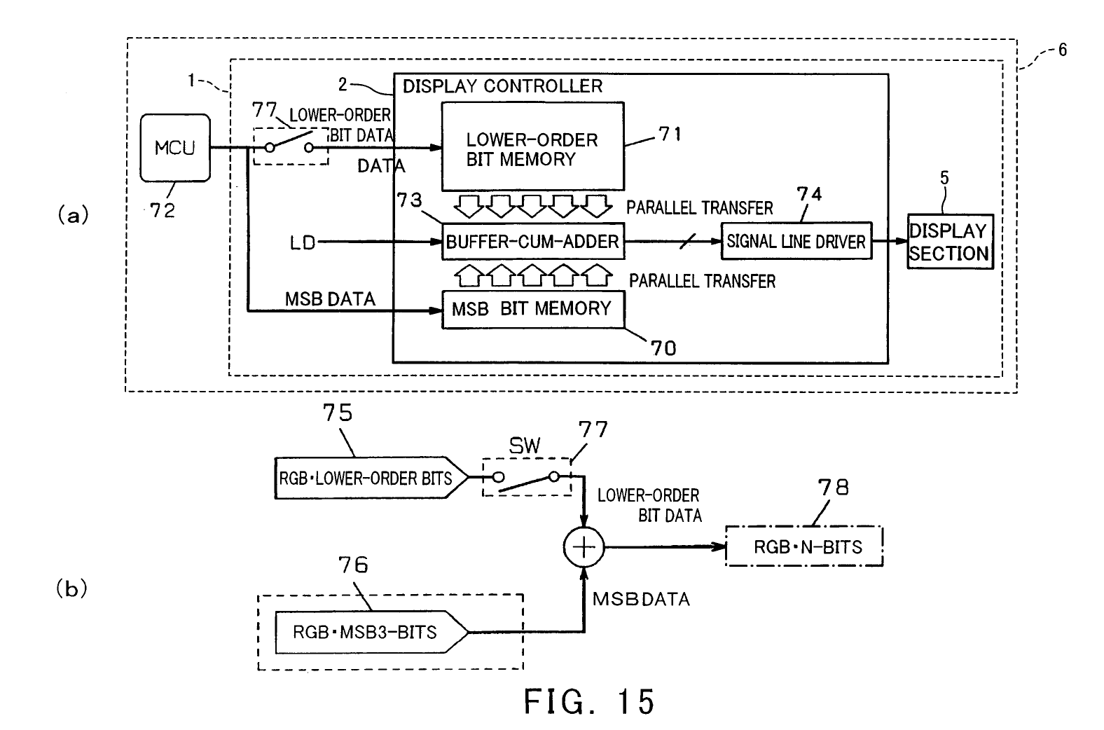

FIG. 15 illustrates the configuration of an image display device according to embodiment 5 of the present invention; specifically, FIG. 15(a) is a block diagram illustrating the configuration, while FIG. 15(b) is a diagram illustrating a computation on pixel data performed in the image display device. As shown in FIG. 15(a), image display device 1 according to embodiment 5 includes a switch 77, a display controller 2, and a display section 5.

The display controller 2 mentioned above includes MSB bit memory 70, lower-order bit memory 71, and a buffer-cum-adder 73. Here, MSB bit memory 70 is adapted to store MSB data (a set of MSBs of pixel data items indicative of respective gradations of red, green and blue) to be inputted from MCU 72 included in electronic apparatus 6. On the other hand, lower-order bit memory 71 is adapted to store lower-order bit data (a set of bits of pixel data items indicative of respective gradations of red, green and blue other than MSBs) inputted from MCU 72. MSB bit memory 70 and lower-order bit memory 71 each comprise SRAM, which does not need any refreshing operation.

The display controller 2 is further provided with a signal line driver 74 for driving signal lines included in the display section 5. That is, the display controller 2 and the signal line driver 74 are integrated together in the image display device 1 according to this embodiment.

When the electronic apparatus 6 is in the normal use state, MCU 72 turns the switch 77 on so that image data for all the pixels can be outputted to the display controller 2. As a result, the display controller 2 drives MSB bit memory 70 and lower-order bit memory 71 so that the MSB data and lower-order bit data of the image data inputted from MCU 72 are written to MSB bit memory 70 and lower-order bit memory 71, respectively. Subsequently, the MSB data and the lower-order bit data are parallel-transferred from the MSB bit memory 70 and the lower-order bit memory 71, respectively, to the buffer-cum-adder 73 with predetermined timing.

The MSB data and the lower-order bit data thus parallel-transferred are added to each other at the buffer-cum-adder 73. Thus, image data for all the pixels is generated. After the buffer-cum-adder 73 latches image data in an amount corresponding to one horizontal period, the image data in an amount corresponding to one horizontal period is parallel-transferred to the signal line driver 74 in accordance with an LD signal. The signal line driver 74, in turn, drives the display section 5 in accordance with the image data. As a result, an image corresponding to the image data is displayed in the display section 5.

On the other hand, when the electronic apparatus 6 is in the standby state, MCU 72 turns the switch 77 off so that only MSB data can be outputted to the display controller 2. As a result, the display controller 2 drives MSB bit memory 70 so that the MSB data of the image data inputted from MCU 72 is written to MSB bit memory 70. In this case lower-order bit data is not inputted from MCU 72 and, hence, lower-order bit memory 71 is not driven. The MSB data thus written is parallel-transferred from MSB bit memory 70 to the buffer-cum-adder 73 with predetermined timing.

The MSB data thus parallel-transferred is latched in an amount corresponding to one horizontal period at the buffer-cum-adder 73. The MSB in an amount corresponding to one horizontal period is then parallel-transferred to the signal line driver 74 in accordance with an LD signal. The signal line driver 74, in turn, drives the display section 5 in accordance with the MSB data. As a result, an image corresponding to the MSB data is displayed in the display section 5.

If the display controller 2 having the buffer-cum-adder 73 and the signal line driver 74 comprise respective separate ICs, a plurality of data buses need be provided between the ICs because data is parallel-transferred from the buffer-cum-adder 73 to the signal line driver 74. This requires routing of external wiring, which increases electric power consumption. For this reason it is desirable that the display controller 2 and the signal line driver 74 be integrated together as in this embodiment.

For easy understanding of the processing described above, description will be made again of this processing with reference to FIG. 15(b). When the electronic apparatus 6 is the in normal use state, the switch 77 is turned on. Accordingly, the display controller 2 adds the MSBs of pixel data items indicative of respective gradations of red, green and blue (represented by RGB MSB3-BITS 76 in the figure) and the lower-order bits of the pixel data items other than the MSBs (represented by RGB LOWER-ORDER BITS 75 in the figure) to each other to generate N-bit pixel data (represented by RGB N-BITS 78 in the figure) where N is a positive integer.

On the other hand, when the electronic apparatus 6 is in the standby state, the switch 77 is turned off. Accordingly, RGB N-BITS 78 consisting only of RGB MSB3-BITS 76 is generated at the display controller 2. In this case the value of N is 3.

Since only MSB bit memory 70 is driven with lower-order bit memory 71 remaining undriven in the standby state of the electronic apparatus 6 as described above, electric power consumption can be reduced.

A further reduction in electric power consumption becomes possible by providing a non-display area as described in embodiment 2 when the electronic apparatus 6 is in the standby state.

It is needless to say that a frame rate control or a duty control based on PWM may be performed to increase the number of displayable colors virtually as the need arises.

As described in embodiment 1, MSB bit memory 70 may have an arrangement such as to enable reading/writing of not MSB data but data on some of higher-order bits of each pixel data item. Such an arrangement will make it possible to adjust the number of displayable colors.

Embodiment 6

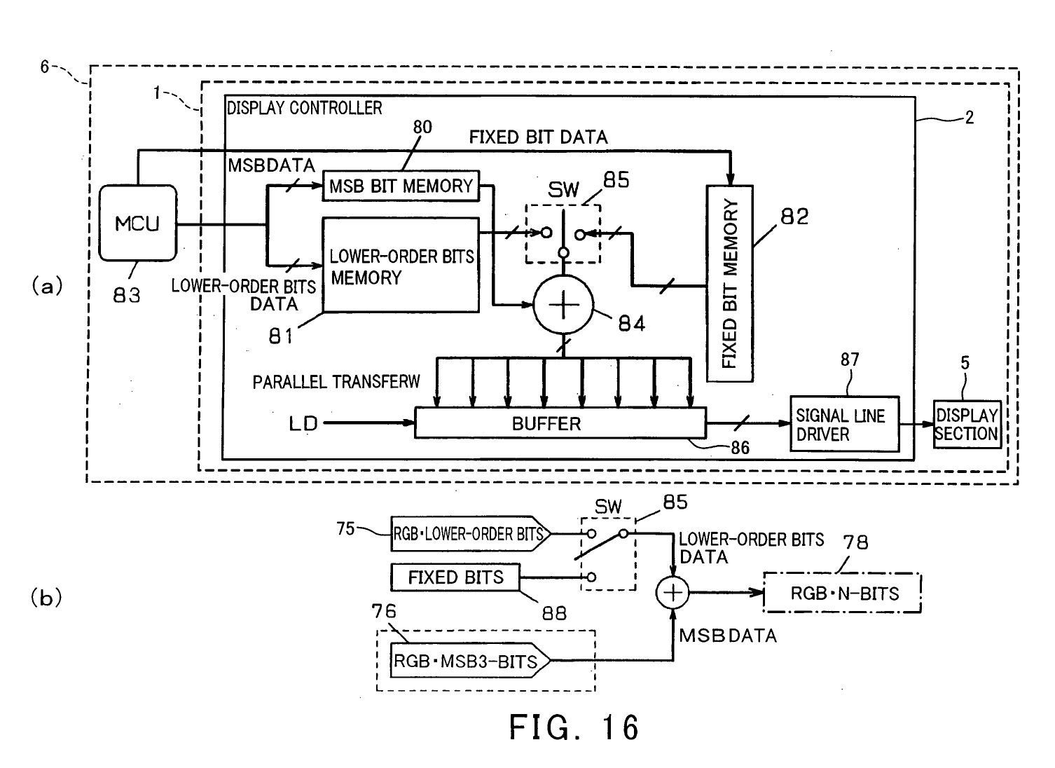

FIG. 16 illustrates the configuration of an image display device according to embodiment 6 of the present invention; specifically, FIG. 16(a) is a block diagram illustrating the configuration, while FIG. 16(b) is a diagram illustrating a computation on pixel data performed in the image display device. As shown in FIG. 16(a), image display device 1 according to embodiment 6 includes a display controller 2 and a display section 5.

The display controller 2 mentioned above includes MSB bit memory 80, lower-order bit memory 81, and fixed bit memory 82. MSB bit memory 80, lower-order bit memory 81 and fixed bit memory 82 each comprise SRAM, which does not need any refreshing operation. Here, MSB bit memory 80 is adapted to store MSB data (a set of MSBs of pixel data items indicative of respective gradations of red, green and blue) to be inputted from MCU 83 included in electronic apparatus 6. Lower-order bit memory 81 is adapted to store lower-order bit data (a set of bits of pixel data items indicative of respective gradations of red, green and blue other than MSBs) to be inputted from MCU 83. Fixed bit memory 82 is adapted to store fixed bit data indicative of a fixed display pattern to be inputted from MCU 83. The fixed bit data is data having a bit width equal to that of lower-order bit data of pixel data for one pixel. It is sufficient for the fixed bit data to be written to fixed bit memory 82 only once in the initialization of the image display device 1.

The display controller 2 further includes a switch 85 for switching between an output from lower-order bit memory 81 and an output from fixed bit memory 82, an adder 84 for adding data outputted through the switch 85 to data outputted from MSB bit memory 80, and a buffer 86 for temporarily storing the sum of data generated by the adder 84.

Further, the display controller 2 is provided with a signal line driver 87 for driving signal lines included in the display section 5. That is, the display controller 2 and the signal line driver 87 are integrated together in the image display device 1 according to this embodiment.

When the electronic apparatus 6 is in the normal use state, MCU 83 instructs the display controller 2 to conduct normal mode processing. In the normal mode the display controller 2 drives MSB bit memory 80 and lower-order bit memory 81 so that MSB data and lower-order bit data are written to MSB bit memory 80 and lower-order bit memory 81, respectively. Subsequently, the display controller 2 reads the MSB data and the lower-order bit data while operating the switch 85 so that continuity is provided between lower-order bit memory 81 and the adder 84. As a result, the adder 84 performs addition of the MSB data and the lower-order bit data to each other to generate image data for all the pixels. The image data thus generated is parallel-transferred to the buffer 86 and then latched thereat. Thereafter, image data in an amount corresponding to one horizontal period is parallel-transferred from the buffer 86 to the signal line driver 87 in accordance with an LD signal. The signal line driver 87, in turn, drives the display section 5 in accordance with the image data. As a result, an image corresponding to the image data is displayed in the display section 5.

On the other hand, when the electronic apparatus 6 is in the standby state, MCU 83 instructs the display controller 2 to conduct processing in the electric power saving mode. In the electric power saving mode the display controller 2 drives MSB bit memory 80 and fixed bit memory 82 so that MSB data and lower-order bit data are read out of MSB bit memory 80 and fixed bit memory 82, respectively, while operating the switch 85 so that continuity is provided between fixed bit memory 82 and the adder 84. As a result, the adder 84 performs addition of the MSB data and the lower-order bit data to each other to generate image data for all the pixels. The image data thus generated is parallel-transferred to the buffer 86 and then latched thereat. Thereafter, image data in an amount corresponding to one horizontal period is parallel-transferred from the buffer 86 to the signal line driver 87 in accordance with an LD signal. The signal line driver 87, in turn, drives the display section 5 in accordance with the image data. As a result, an image corresponding to the image data is displayed in the display section 5.

If the display controller 2 having the buffer 86 and the signal line driver 87 comprise respective separate ICs, a plurality of data buses need be provided between the ICs because data is parallel-transferred from the buffer 86 to the signal line driver 87. This requires routing of external wiring, which increases electric power consumption. For this reason it is desirable that this embodiment have the display controller 2 and the signal line driver 87 integrated together like embodiment 5.

For easy understanding of the processing described above, description will be made again of this processing with reference to FIG. 16(b). In the normal mode, the switch 85 is operated so that the MSBs of pixel data items indicative of respective gradations of red, green and blue (represented by RGB MSB3-BITS 76 in the figure) and the lower-order bits of the pixel data items other than the MSBs (represented by RGB LOWER-ORDER BITS 75 in the figure) are added to each other. As a result, N-bit pixel data (represented by RGB N-BITS 78), where N is a positive integer, is generated.

In the electric power saving mode, on the other hand, RGB-MSB3-BITS 76 and fixed bits 88 are added to each other to generate RGB-N-BITS 78. In this case the bits of RGB-N-BITS 78 other than MSBs are common values for all the pixels.

In the normal mode the image display device according to this embodiment needs to read the lower-order bit data of pixel data for all the pixels by driving lower-order bit memory 81. In the electric power saving mode, on the other hand, it is sufficient to read only fixed bit data having a bit width equal to that of the lower-order bit data of pixel data for one pixel by driving fixed bit memory 82. For this reason, a reduction in electric power consumption can be achieved in the electric power saving mode.

A further reduction in electric power consumption becomes possible by providing a non-display area as described in embodiment 2 in the electric power saving mode.

As described above, it is sufficient for fixed bit data to be written to fixed bit memory 82 only once in the initialization of the image display device 1. However, the image display device 1 may be configured to be capable of appropriately varying the values of fixed bit data with desired timing. Such a configuration will make it possible to adjust the brightness of the screen for example.

It is needless to say that a frame rate control or a duty control based on PWM may be performed to increase the number of displayable colors virtually as the need arises.

As described in embodiment 1, MSB bit memory 80 may have an arrangement such as to enable reading/writing of not MSB data but data on some of higher-order bits of each pixel data item. Such an arrangement will make it possible to adjust the number of displayable colors.

It will be apparent from the foregoing description that many improvements and other embodiments of the present invention occur to those skilled in the art. Therefore, the foregoing description should be construed as an illustration only and is provided for the purpose of teaching the best mode for carrying out the present invention to those skilled in the art. The details of the structure and/or the function of the present invention can be modified substantially without departing from the spirit of the present invention.

### INDUSTRIAL APPLICABILITY

The image display device according to the present invention is particularly useful as a display device for small-sized electronic apparatus such as mobile telephones and PDAs.

1. An image display device comprising:
a display section having a plurality of pixels for image display; and
image memory which is operative to store pixel data associated with colors to be displayed by the pixels and which does not need any refreshing operation,
the image memory having first memory for storing a predetermined bit of the pixel data and second memory for storing bits of the pixel data other than the predetermined bit,
the image display device having an arrangement capable of switching between a first mode in which the predetermined bit is read out of the first memory and the display section is caused to display an image in accordance with the predetermined bit thus read out and a second mode in which the predetermined bit and the bits other than the predetermined bit are read out of the first memory and the second memory, respectively, and the display section is caused to display an image in accordance with the predetermined bit and the bits other than the predetermined bit thus read out.

2. The image display device according to claim 1, wherein the pixel data comprises data items indicative of respective gradations of the three primary colors and the predetermined bit of the pixel data comprises a set of respective predetermined bits of the data items indicative of the respective gradations of the three primary colors.

3. The image display device according to claim 2, wherein the predetermined bit of the pixel data comprises a set of respective MSBs of the data items indicative of the respective gradations of the three primary colors.

4. The image display device according to claim 1, wherein in the first mode the predetermined bit is read out of the first memory and the display section is caused to display the image by a frame rate control exercised in accordance with the predetermined bit thus read out.

5. The image display device according to claim 1, wherein in the first mode the predetermined bit is read out of the first memory and the display section is caused to display the image by a duty control based on pulse width modulation in accordance with the predetermined bit thus read out.

6. An image display device comprising:
a display section having a plurality of pixels for image display; and
image memory which is operative to store pixel data associated with colors to be displayed by the pixels and which does not need any refreshing operation,
the image memory having first memory for storing a predetermined bit of the pixel data and second memory for storing bits of the pixel data other than the predetermined bit,
the image display device having an arrangement capable of switching between a first mode in which a predetermined bit of pixel data for a predetermined pixel is read out of the first memory and the display section is caused to display an image in accordance with the predetermined bit thus read out and a second mode in which the predetermined bit and the bits other than the predetermined bit of pixel data for each of the pixels are read out of the first memory and the second memory, respectively, and the display section is caused to display an image in accordance with the predetermined bit and the bits other than the predetermined bit thus read out.

7. The image display device according to claim 6, wherein the pixel data comprises data items indicative of respective gradations of the three primary colors and the predetermined bit of the pixel data comprises a set of respective predetermined bits of the data items indicative of the respective gradations of the three primary colors.

8. The image display device according to claim 7, wherein the predetermined bit of the pixel data comprises a set of respective MSBs of the data items indicative of the respective gradations of the three primary colors.

9. The image display device according to claim 6, which has an arrangement capable of changing the predetermined pixel in the first mode.

10. An image display device comprising:
a display section having a plurality of pixels for image display, and
image memory which is operative to store pixel data associated with colors to be displayed by the pixels and which does not need any refreshing operation,
the image memory having first memory for storing a predetermined bit of pixel data for each of the pixels and second memory for storing bits of the pixel data other than the predetermined bit,
the image display device having an arrangement capable of switching between a first mode in which: a specific pixel is selected from the plurality of pixels depending on a residual capacity of an electric power supply battery; a predetermined bit of pixel data for the specific pixel thus selected is read out of the first memory or the predetermined bit and the bits other than the predetermined bit of the pixel data for the specific pixel thus selected are read out of the first memory and the second memory, respectively; and the display section is caused to display an image in accordance with the predetermined bit read out or in accordance with the predetermined bit and the bits other than the predetermined bits read out and a second mode in which: a predetermined bit and bits other than the predetermined bit of pixel data for each of the pixels are read out of the first memory and the second memory, respectively; and the display section is caused to display an image in accordance with the predetermined bit and the bits other than the predetermined bit thus read out.

11. The image display device according to claim 10, wherein the pixel data comprises data items indicative of respective gradations of the three primary colors and the predetermined bit of the pixel data comprises a set of respective predetermined bits of the data items indicative of the respective gradations of the three primary colors.

12. The image display device according to claim 11, wherein the predetermined bit of the pixel data comprises a set of respective MSBs of the data items indicative of the respective gradations of the three primary colors.

13. An image display device comprising:
a display section having a plurality of pixels for image display;
first memory and second memory which are operative to store pixel data associated with colors to be displayed by the pixels and which do not need any refreshing operation; and
a control section for switching between a first mode in which pixel data for each of the pixels is written to the first memory and a second mode in which a predetermined bit of the pixel data for each of the pixels is written to the second memory, wherein
in the first mode the pixel data for each of the pixels is read out of the first memory and the display section is caused to display an image in accordance with the pixel data thus read out, whereas in the second mode the predetermined bit of the pixel data for each of the pixels is read out of the second memory and the display section is caused to display an image in accordance with the predetermined bit of the pixel data thus read out.

14. The image display device according to claim 13, wherein the pixel data comprises data items indicative of respective gradations of the three primary colors and the predetermined bit of the pixel data comprises a set of respective predetermined bits of the data items indicative of the respective gradations of the three primary colors.

15. The image display device according to claim 14, wherein the predetermined bit of the pixel data comprises a set of respective MSBs of the data items indicative of the respective gradations of the three primary colors.

16. An image display device comprising:
a display section having a plurality of pixels for image display;
first memory which is operative to store a predetermined bit of pixel data associated with colors to be displayed by the pixels and which does not need any refreshing operation;
second memory which is operative to store bits of the pixel data other than the predetermined bit and which does not need any refreshing operation; and
third memory which is operative to store fixed data having a bit width equal to the bits of the pixel data other than the predetermined bit and which does not need any refreshing operation,
the image display device having an arrangement capable of switching between a first mode in which: the predetermined bit and the bits other than the predetermined bit are read out of the first memory and the second memory, respectively; and the display section is caused to display an image in accordance with the predetermined bit and the bits other than the predetermined bit thus read out and a second mode in which: the predetermined bit and the fixed data are read out of the first memory and the third memory, respectively; and the display section is caused to display an image in accordance with the predetermined bit and the fixed data thus read out.

17. The image display device according to claim 16, wherein the pixel data comprises data items indicative of respective gradations of the three primary colors and the predetermined bit of the pixel data comprises a set of respective predetermined bits of the data items indicative of the respective gradations of the three primary colors.

18. The image display device according to claim 17, wherein the predetermined bit of the pixel data comprises a set of respective MSBs of the data items indicative of the respective gradations of the three primary colors.

19. The image display device according to claim 16, which has an arrangement capable of changing the fixed data.

20. An electronic apparatus comprising: an image display device as recited in claim 1; and an arrangement for outputting pixel data to the image display device.
